(19) United States
(12) Patent Application Publication
(10) Pub. No.: US 2003/0033406 A1
(43) Pub. Date: Feb. 13, 2003

(54) Apparatus for and a method of network load testing

(76) Inventors: Rekesh John, Pleasanton, CA (US); Mahesh Pratapneni, Dublin, CA (US)

Correspondence Address: HAVERSTOCK & OWENS LLP, 162 NORTH WOLFE ROAD, SUNNYVALE, CA, 94086, US

(21) Appl. No.: 10/172,562

(22) Filed: Jun. 13, 2002

Related U.S. Application Data
(60) Provisional application No. 60/298,356, filed on Jun. 14, 2001.

(51) Int. Cl. G06F 15/173

(52) U.S. Cl. 709/224; 709/230

(57) ABSTRACT

PATENT A network load tester includes a proprietary software based real-time operating system operating on conventional processor chips and network processors. Network processors are specialized processors for handling various network-oriented tasks at wire speed, and are micro-programmable and configurable on-the-fly. All testing configuration is driven by software, and customized application or protocol stacks can be loaded dynamically onto the network load tester to run under the real-time operating system. This device can be readily reconfigured for testing various applications and appliances across all layers of the OSI stack, even remotely through a network connection.

### RELATED APPLICATIONS

This application claims priority under 35 U.S.C. §119(e) of the co-pending U.S. Provisional Patent Application Serial No. 60/298,356 filed Jun. 14, 2001 and entitled “An Apparatus For A Method Of Network Load Testing.” The Provisional Patent Applications Serial No. 60/298,356 filed Jun. 14, 2001 and entitled “An Apparatus For A Method Of Network Load Testing” is also hereby incorporated by reference.

### FIELD OF THE INVENTION

The present invention relates to an apparatus for network load testing. More particularly, this invention relates to a dynamically re-configurable device for load testing of software and network appliances at wire speed over a network.

### BACKGROUND OF THE INVENTION

Conventionally, companies have tested high speed networks with logic built into hardware. The need to test and validate hardware performance at today's high transmission speeds has relied on logic built into hardware to achieve the capability to generate test loads and monitor traffic at wire speed. The hardware design and implementation task for such a device is a time-consuming one, using Field Programmable Gate Arrays (FPGAs) or Application Specific Integrated Circuits (ASICs) to implement the design. Once the design is frozen, only limited on-the-fly or in-the-field logic changes are possible. This has resulted in hardware-based network testing devices being extremely limited in their ability to work with complex and ever evolving protocols. Such devices cannot generally handle new applications, protocols or variations without costly and time-consuming hardware redesign and modifications.

Testing solutions based on ASICs and FPGAs can test only the software or hardware they were designed for. During the design process there may literally be hundreds of permutations in hardware and software by the product design teams. The ability to have a flexible testing apparatus is an extremely valuable tool. The long design and manufacture cycles of hardware-based test apparatus means that purely hardware-based test solutions are not readily or cost effectively configurable or flexible to use with the changing protocols and applications that are characteristic of today's technology. Additionally, such apparatus is functionally unfit and not cost-effective for use in research and development environments. The long design and/or manufacture cycles of hardware based test apparatus mean that hardware-based test solutions are not readily or cost effectively configurable or flexible enough to use during this process. This makes them functionally unfit and not cost-effective for use in true research and development situations.

Current hardware-based test solutions require specialized boards necessitated by the different logic in the ASIC and FPGA chips. It is very common to have at least three or four specialized boards in a test configuration to test various protocol stacks, applications and devices. This can be required even if there is no requirement to test these applications simultaneously.

Another common testing configuration is to literally set up hundreds of PC's running test software, each configured with a message or request for a server application, and synchronize their service requests and measure the responses for time and accuracy. Such an approach is logistically difficult, expensive, and time consuming to set-up. However, for a narrow set of applications this approach can more easily adapt to new protocols or services than the hardware based testing solutions. This method of testing is referred to as software-based testing.

Network load testing is applied to numerous industries including Internet Platform Manufacturers, Internet Service Providers, Network and Telecommunications Providers, and Web Services, to name a few. Such applications cover the range of the Open Systems Interconnection (OSI) reference model. This industry standard segregates various functionality of a data communications application. With the advent of the Internet, the OSI model for supporting business applications has become more prominent. FIG. 1 shows a comparison between the OSI model and the Transmission Control Protocol/Internet Protocol (TCP/IP). TCP/IP is the protocol used on the Internet. As can be seen from FIG. 1, the TCP/IP Internet protocol suite can be mapped to the OSI model. The traditional Network Layer (layer 3) has been replaced with the Internet. Hardware-based test solutions that traditionally target layers 1 through 3 have spent considerable time and resources in migrating their ASIC based testing solutions to support the Internet at layer 3 and below.

The OSI session layer (layer 5) permits two parties to hold ongoing communications called a session across a network. The session layer handles session setup, data or message exchanges, and tear down when the session ends. The TCP/IP model does not have an explicit session layer because most of the characteristics of the session layer are provided by the TCP protocol and the term session is not used. If a TCP/IP application requires a special session service they provide their own.

The OSI presentation layer (layer 6) handles data format information for networked communications. For outgoing messages, the presentation layer converts data into a generic format that can survive the rigors of network transmission. For incoming messages, the presentation layer converts the generic representation into a format that will make sense to the receiving application. An example of this generic format is called abstract syntax notation.1 (ASN.1). As with the session layer, the presentation layer is not present in the TCP/IP model. Instead, this function is frequently handled within the applications in TCP/IP through some TCP/IP protocols like external data representation standard (XDR) and multipurpose Internet mail extensions (MIME).

In TCP/IP, each application is composed of whatever set of functionality it needs to support a distributed communications service, e.g. the exchange of mail or remote file access, into the protocols of that particular application. In other words, each application process builds its own, often unique set of tools, commands, and exchange mechanisms. Changing dynamics such as these are not conducive to hardware-based testing solutions. Hardware-based solutions are not easily adapted to higher-level testing (layer 4 and higher of the OSI model). Testing of protocols above layer 3 is complicated due to the varying needs of individual applications and the difficulty in applying inflexible hardware logic to such application-specific scenarios. This makes hardware-based testing solutions less viable for Internet service providers and web services.

Software-based solutions run load-generating applications on a large group of computers (typically PCs) and are primarily meant for web site testing. Per-user simulation is expensive. Large numbers of PCs (in some instances 200 PCs) are required to scale the generated load. Administrative, maintenance and real estate costs also add up significantly.

As an example of an application that requires network load testing, consider the case of an email processing server. To generate email load to the email-processing server, a load generator needs to run SMTP (Simple Mail Transfer Protocol), POP (Point Of Presence) and IMAP (Internet Messaging Access Protocol) protocols over the TCP/IP protocol stack, and be capable of creating and receiving MIME (Multipurpose Internet Mail Extensions)-encoded email, among others. These are the equivalent of OSI reference model layers 4 through 7. The hardware-based test solutions do not sufficiently address these levels. They can generate custom crafted and scripted IP packets in large volumes. However, this is a only “feel good” simulation of network load and such capabilities are far inferior from actually implementing the protocols that are used on networks. A custom scripted packet emitter in no way compares to the actual protocol itself being used for load generation.

What is needed is a network load testing device that provides the high-performance necessary to be applied to applications and devices utilizing high transmission speeds. What is also need is a network load testing device that provides flexibility and adaptability to meet changing protocols and applications. What is needed is network load testing device that can be used across layers 1-7 of the OSI reference model.

What is further needed is a simpler network load testing device that does not require specialized components for implementation.

### SUMMARY OF THE INVENTION

A network load tester of the present invention includes a proprietary software based real-time operating system operating on conventional processor chips and network processors. Network processors are specialized processors for handling various network-oriented tasks at wire speed, and are micro-programmable and configurable on-the-fly. All testing configuration is driven by software, and customized application or protocol stacks can be loaded dynamically onto the network load tester to run under the real-time operating system. This device can be readily reconfigured for testing various applications and appliances across all the OSI layers, even remotely through a network connection.

### BRIEF DESCRIPTION OF THE DRAWINGS

FIG. 1 illustrates the Open Systems Interconnect Model and the Transmission Control Protocol/Internet Protocol.

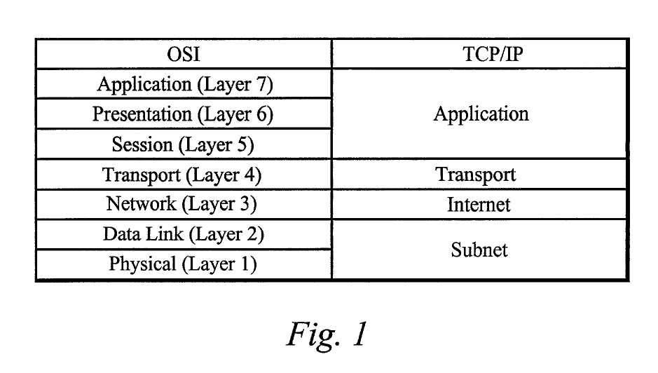

FIG. 2 illustrates a functional block diagram of a chassis according to a preferred embodiment of the present invention.

FIG. 3 illustrates a block diagram of a processor board 12 according to the preferred embodiment of the present invention.

FIG. 4 illustrates an exemplary chassis chain and control network according to the present invention.

FIG. 5 illustrates a method of creating and applying a test suite of real-life load patterns to a device under test.

FIG. 6 illustrates a software module according to the preferred embodiment of the present invention.

### DETAILED DESCRIPTION OF THE EMBODIMENTS

The network load testing device of the present invention combines the power of hardware wire-speed processing with the flexibility of specialized software to generate testing loads at wire speed. Wire-speed means that the device shall be capable of generating, consuming and processing data packets on its network interfaces at the respective speeds of those interfaces. Such a device is highly flexible and, at the same time, capable of very high throughput.

This “hybrid” approach of the present invention involves a device running a small-footprint operating system and wire-speed network processors incorporated into a single intelligent board. Network processor building blocks are specialized processors for handling various network-oriented tasks at wire speed, and are micro-programmable and configurable on-the-fly. This requires hardware logic at the lower layers (layers 1, 2, 3 of the OSI model). Higher levels require protocol stacks running under a real-time operating system on an on-board processor and memory. Such on-board processors and memory are commercially available from several major chip manufacturers including Motorola and Intel. The real-time operating system is a lightweight, thin operating system that is coded for real-time mission control. The operating system is real-time because the network processors process the network packets at a very high rate, and the operating system must support that level of input coming in from the network.

All testing configuration is driven by software, and customized application or protocols stacks can be loaded dynamically onto the device to run under the real-time operating system. This device can be readily reconfigured for testing various applications and appliances on-the-fly, even remotely through a network connection.

The hybrid approach of the network load testing device of the present invention provides significant advantages. These advantages include flexibility to download customer configured test sequences, flexibility to download new application requirements and protocol updates, lower cost of ownership since new test features are available quicker and cheaper due to software design, ability to interface with legacy systems and to reuse investments in legacy testing devices, support for online testing through easy access of remote systems via the Internet, and ability to perform smooth version upgrades through software.

Preferably, the network load test device provides testing to core Internet infrastructure and services and web services, such as Voice over IP (VoIP), streaming audio/video, firewalls, Wireless Application Protocol (WAP) and wireless gateways, and many more. Examples of Internet infrastructure include high-speed Internet infrastructure routers such as long-haul core routers, metro core and access routers. Long-haul networks focus on moving data and voice traffic across long distances, usually several hundred kilometers. Two types of technologies are used here: SONET and DWDM (Dense Wave Division Multiplexing) using optical cross-connects. Core routers or switches support OC-12c/STM-4c 622 Mb/s, OC-48c/STM-16c 2.4 GB/s and OC192/STM-64c 10 GB/s packet over SONET/SDH. In this case, protocols such as MPLS, BGP, OSPF, ISIS and TCP/IP are used. Metro networks focus on metropolitan areas and can be segmented as the metro-core and metro-edge (or access) networks. Metro core typically uses DWDM like the long haul, for interoffice ring transport between central offices, point-of-presences and data centers. Metro Edge typically uses SONET rings and feeds packets into end-user buildings. Direct Gigabit Ethernet over fiber access to the Metro networks is also available.

Web services are typically implemented by web servers and application servers (like WebSphere) that talk to back-end systems, including databases. Next-generation web services use SOAP and XML to link software to one another. Appliance servers are hot-pluggable application servers for services like web servers, email, streaming video, FTP and so on. Other web services include public key infrastructure (PKI) services and business-to-business transactions.

Network appliances can also be tested by the network load tester of the present invention. Network appliances are those devices sitting on a network infrastructure that facilitate operations. These devices are characterized by the need to interoperate with similar or other network appliances. Network appliances can include Virtual Private Network (VPN) devices, load balancers, and firewalls, to name a few. Other network devices such as softswitches, content caching devices, content delivery network infrastructure, and PKI can also be tested by the network load tester of the present invention.

It is understood that other network devices and applications can be tested by the network load testing device of the present invention.

The network load testing device primarily performs two types of testing, capacity testing and conformance testing. Capacity testing generates customer definable load to be transmitted to a device under test. The number of packets received from the device under test is measured to determine at what point the device under test can no longer operate without losing packets or causing excessive latency in transmission, or corrupting packets. Conformance testing concerns itself with whether or not an application or network element performs as expected to a specific protocol. New hardware and applications are being designed to operate in the Internet environment. As a result compliance to the many and frequently changing protocols in the TCP/IP environment is required for these devices and applications. Due to the dynamic nature of protocols above layer 3, most hardware-based test systems do not support these protocols or provide limited support for them.

A preferred network load tester of the present invention includes the real-time operating system, a CPU, a high-speed memory resource, and configurable wire-speed network processors incorporated onto a single intelligent board, referred to as a processor board. Network processors are hardware building blocks that can be micro-programmed dynamically and perform wire-speed processing of network packets. Application-specific software protocol stacks are loaded onto the processor board, with lower layers of the protocol stack being replaced with direct interfaces to the wire-speed network processors. The software protocol stacks are customized to be of thin footprint, requiring only those parts necessary for the testing at hand. The processor board supports multiple ports to a media interface such as Ethernet or high-speed optics. Different boards will be required for different types of media interfaces. A single board can also offer multiple interface types.

Multiple processor boards can be plugged into a chassis to scale the performance and capabilities beyond that offered by a single board. The standard chassis holds multiple processor cards to accommodate many different types of transmission media. Any processor board in the test system can be configured on demand to run a specified network protocol stack and application logic. The dynamic reconfiguration takes place under the control of a Test Director that down loads the specified protocol stacks and the test configuration to the processor boards. The Test Director is preferably a personal computer running Windows with proprietary test software that configures and controls each chassis. Multiple chasses can be chained together to scale to a multi-box solution, if required by a specific implementation. Each chassis can be directly connected to a CRT, keyboard and mouse, but it is preferable to connect all chasses via an Ethernet network and run the client software on an external workstation. The Test Director can down load customer configurations, and store test results for later analysis. The Test Director includes software that can configure the board, load test suites, monitor tasks, report and collect test results. A storage system can be attached to the control board, the processor boards, or on the network for data storage purposes. Storage systems can include Small Computer System Interface (SCSI) disks, for example.

The network load testing system can be quickly reconfigured for testing various applications and appliances on the fly, even remotely through a network connection. All configurations are preferably driven by software. This allows customized applications or protocol stacks to be loaded dynamically onto the test system to run under the real-time operating system.

A control board includes interface software and is used to communicate with one or more chassis or Test Directors. This software also facilitates communication with other processor boards in the system to coordinate testing so that large-scale testing operations can be orchestrated.

The processor board is able to generate sufficient loads to utilize the complete network bandwidth. Since the processor boards include the required network and application protocols, the network load testing device has an efficient implementation to communicate with the appliance or application being tested. Coupled with the ability to generate test cases for the application or appliance, the network load testing device is extremely efficient for different types of testing, including load generation testing and conformance testing.

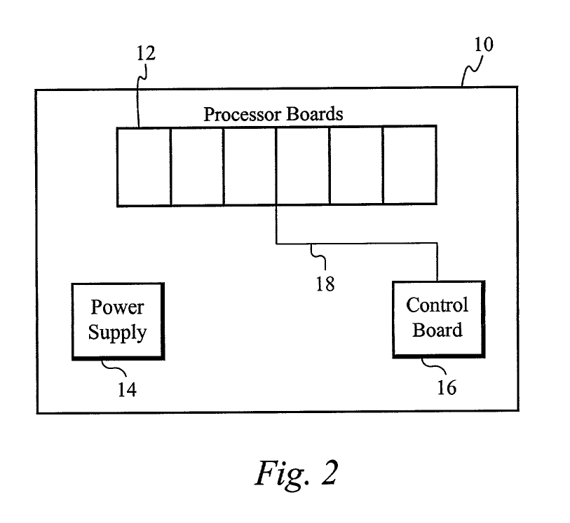

The network load testing device of the present invention includes a hardware framework and a software framework. The hardware framework includes the chassis, the processor boards, and the control board. FIG. 2 illustrates a functional block diagram of a chassis 10 according to a preferred embodiment of the present invention. Each chassis includes a control board 16, a high-speed bus 18, such as a PCI bus, processor boards 12, and a power supply 14. Each chassis 10 can operate as a stand alone system to allow local analysis of test results. Multiple processor boards 12 can plug into a high-speed bus 18. A standard PC motherboard can be used; however, the motherboard functionality is preferably incorporated into the control board 16, which can be plugged into the chassis 10. The chassis 10 enables processor boards 12 to communicate with each other over the bus 18, as well as enables the processor boards 12 to be controlled and monitored from an external environment, such as the Test Director. The bus 18 also enables the processor boards 12 to communicate and be controlled by the control board 16. The control board 16 can interface with external systems through a high-speed ethernet link.

The processor boards can be configured on the fly to load any test suite and run an associated test. A test suite includes specific parameters for a particular test to be performed, as is well known in the art. The processor boards are reusable and dynamically configurable for various test suites. The processor boards are generic in the sense that one processor board can be sufficient for testing all protocols and applications through one interface type. Although these processor boards differ in the media to which they interface, each has a common footprint and set of functions. Multiple processor boards supporting the same interface type can be used to scale the testing solution. Each processor board can be configured to run different test suites. Bug-fixes, patches, updates, as well as new releases can be applied on the fly, even from a remote location over the network.

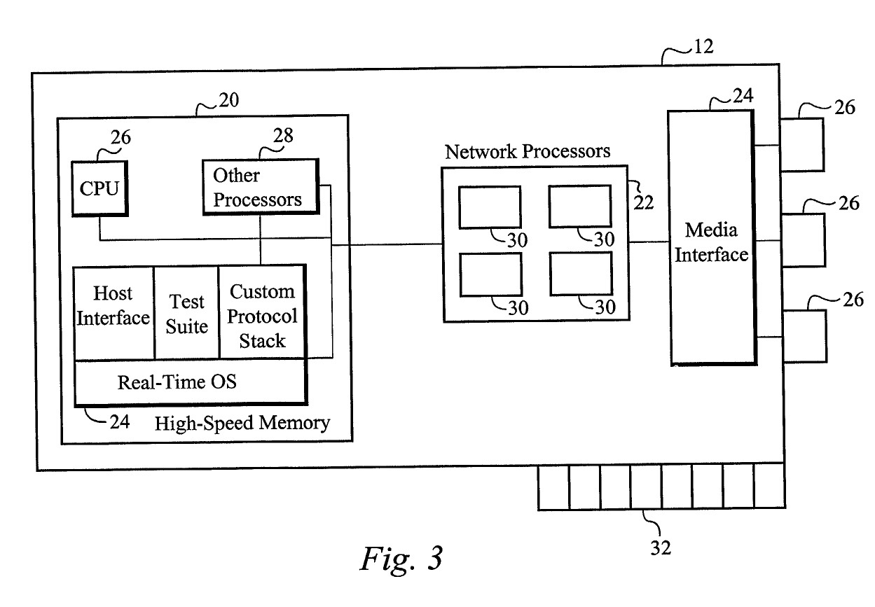

FIG. 3 illustrates a block diagram of a processor board 12 according to the preferred embodiment of the present invention. The processor board 12 includes a high-level processing section 20, a low-level processing section 22, a media interface 24 and one or more ports 26. The processing board 12 also includes a high-speed I/O bus 32 for connecting to the bus 18 (FIG. 2) on the chassis 10 (FIG. 2). The high-level processing section 20 preferably includes process application protocols corresponding to the layers 4-7 of the OSI reference model. The low-level processing section 22 preferably includes process network protocols corresponding to the layers 1-3 of the OSI reference model.

The low-level processing section 22 includes one or more network processors 30. Although FIG. 3 shows 4 network processors 30, more or less network processors 30 can be used. The network processors 30 are preferably ready-made (off-the-shelf) building blocks for packet processing for wire-speed packet handling as well as generation. The network processors 30 also has the ability to perform wire-speed packet routing, table lookups, packet disassembly, rule-based engine matching and so on. The network processors 30 can be micro-programmed to behave specifically for protocols under consideration.

The high-level processing section 20 includes a CPU 26 and a high-speed memory 24. The high-speed memory 24 includes software for running a host interface, a test suite, custom protocol stack, and a real-time operating system. For applications using higher layers of the OSI model (like the Internet services), the protocol stacks need to run at high speed so that the network capacity can be fully utilized. Therefore, a high-performance CPU 26 and onboard memory 24 are preferred in order to run these protocol stacks on top of a lightweight and fast, embedded real-time operating system. The real-time operating system runs the protocol stacks as well as the test suite. Preferably, the real-time operating system is a high performance operating system, is fully resident in memory, has minimal processing overheads, and is able to fully saturate a network interface in terms of packet processing and generation. Preferably, the in-memory footprint of the real-time operating system does not exceed 1 MB. The test suite, when loaded, preferably resets and configures the network processors 30 (FIG. 2) for optimal performance for the protocols being used. Lightweight, custom-tailored TCP/IP and other protocol stacks are used with the real-time operating system for high performance. Usual protocol stacks available off the shelf, for example TCP/IP, are not configured or built for load-testing purposes. They cannot reliably handle a very large number of IP addresses, nor provide hooks or configurable features for tweaking parameters. They can also suffer from limited parallelism and throughput can be affected when scaling to a very large number of connections. These protocol stacks are also not modular, in the sense that unwanted functionality cannot be shunted off and removed.

The high-level processing section 20 also preferably includes other processors 28 which can be used as required. These other processors 28 are implementation specific, but include processors such as crypto-accelerator chips for cryptographic operations like those used in SSL (Secure Socket Layer) and VPN.

The media interface 24 enables communications over various communication mediums. Such mediums include 10/100 Ethernet, Gigabit and 10 Gb Ethernet, OC-3 to OC-192 Fiber Optics, SONET, and ATM. It is understood that other media interfaces can be included in the processor board. Preferably, each processor board 12 supports one media interface type. Preferably, the media interface 24 includes chips/chipsets capable of handling a very large number of packets (as relevant to the interface speed) without queuing delays or dropping packets. Each processor board 12 preferably supports multiple ports for a single media interface type. This may vary based on the port density the latest technology allows for the interface type.

Ports on the processor boards provide high-speed transmit, capture and statistics operation. The contents of every packet can be programmable in terms of structure and data content. Preamble size, frame size, destination and source MAC addresses are other examples of programmable items. Each port will have a buffer, typically a few MB in size. Data recorded into the capture buffer after capture can be triggered. Packets held in the capture buffer are filtered as well and the amount of data per packet can be limited. Each port can automatically collect a wide range of statistics. Most of the statistics are pre-programmed, while others can be selected or user programmed. The pre-programmed statistics include frames sent, valid frames received, fragments received, bytes sent and received, undersized and oversized packets, FCS errors, VLAN tagged frames received, code violations and flow control frames. For a Gigabit Ethernet interface, the preprogrammed statistics can also include CRC errors and byte alignment errors.

The control board 16 (FIG. 2) in effect implements the motherboard, hosting a CPU, memory and software for basic communication and management. Preferably, the control board 16 also includes a high-speed ethernet interface to communicate with an external host or user. The control board can also provide access to a storage system, for example using a SCSI interface. The control board 16 hosts test-management software and interfaces with external host systems, such as the Test Director, driving the tests.

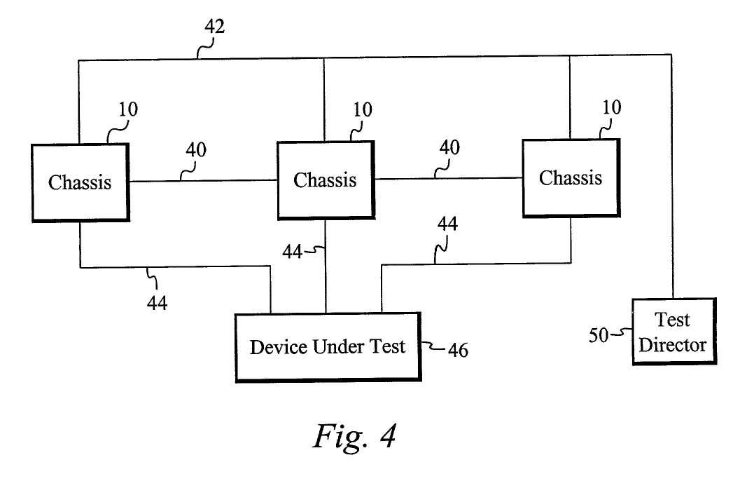

The network load testing system of the present invention can be scaled by chaining together multiple chasses. The chasses can also be geographically separated. Multiple chasses can be chained together through special sync-out/sync-in connections that allow for port-to-port synchronization across an entire system within a few nanoseconds. Ports from the chasses are connected to a Device Under Test (DUT) using cables appropriate for the media (RJ45, Fiber, USB, etc.). FIG. 4 illustrates an exemplary chassis chain and control network according to the present invention. Multiple chasses 10 are coupled together via sync-out/sync-in connections 40. Each chassis 10 is coupled to a Test Director 50. Preferably, the Test Director 50 and the chasses 10 are coupled over an Ethernet connection 42, although other media can be used. Each chassis 10 is coupled to a device under test 46 via a cable 44. Ports from any of the chassis 10 can be coupled to the device under test 46. Additionally, multiple independent devices under test can be coupled to the same chassis.

The network load testing device of the present invention also includes the software framework. The software framework includes a software framework on the processor boards, testing software on the processor boards, and a software framework on the control boards. The software framework on the processor boards includes the real-time operating system for high-speed processing, a management-interface software to receive testing instructions, perform monitoring commands and report test results, customized application protocol stacks for the applications/devices being tested, and customized protocol implementations for router protocols tested. The customized application protocol stacks include TCP/IP protocols, Voice over IP protocols, VPN protocols, and next generation web services protocols. It is understood that other customized application protocol stacks can also be included. The customized router protocols include MPLS (Multi-Protocol Labeled Switching), BGP (Border Gateway Protocol), OSPF (Open Shortest Path First), and ISIS (Intermediate System-to-Intermediate System). It is understood that other customized router protocols can also be included. It is also understood that customized protocols for network devices other than routers can be included.

Test suites can include special databases used as templates to create simulated load patterns for testing applications. These databases are specific to application domains and are derived from the analysis of real-life load on similar applications that are already deployed in the field. When used with the network load tester, these databases effectively simulate real-life loading patterns that can be expected when the application is deployed. This enables reliability, availability, performance and scalability tests to be conducted effectively on the application. This is especially useful in the phases of testing that are conducted before the application is deployed in the field. It is understood that test suites are applied to devices as well as applications.

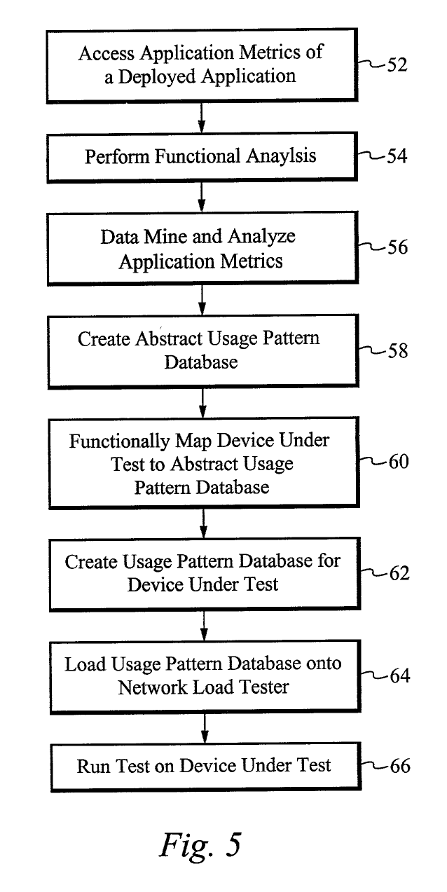

Alternatively, real-life load pattern databases are used for load testing applications. FIG. 5 illustrates a method of creating and applying a test suite of real-life load patterns to a device under test (DUT). An operational load of a deployed and running application is extracted from the application's metrics at the step 52. These metrics are typically present in most applications in the form of operational logs. In the case of a web-based application, the web server logs constitute important operational logs. The application can also have additional metrics incorporated. At the step 54, the application metrics are analyzed functionally to identify the various supported operations or functoids, as well as the entities (actors) executing those operations. Then, at the step 56, the application metrics are mined and analyzed to identify functoid usage patterns that are actually exercised in real life. Functoids represent typical classes of operations performed in the application domain. Put together, functoids represent the complete (or relevant) functionality of the application. Functoids can also be nested. That is, functoids can be comprised of other functoids.

For example, a web-based application selling used cars online has actors like car dealers, car buyers, car sellers and so on. Actors represent subsystems. For example, an external news input system or a 3^{rd} party payment system are considered actors. There are functoids representing the operations done by or on these actors. Each functoid has its own set of sub-functoids. For example, a buyer functoid can include functoids that represent searching for cars, viewing information, posting notices, browsing, negotiations, purchase and so on. Each of these can again be decomposed into sub functoids. Functoids can also take parameters that represent a specific type of usage of the functoid. For example, a search for cars using specific keywords (like Toyota 1998) is an example of a functoid that takes parameters.

After data mining and analyzing the metrics from a sample deployed application or device at the step 56, an abstract usage pattern database for the application is created at the step 58. This abstract usage pattern database contains all the functoid definitions, actor types and their instances, and the details of parametric functoid execution by the various actor instances. The abstract usage pattern database is then further processed to remove redundant information as well as non-disclosable information. For parametric functoid executions carrying non-disclosable information, execution templates are created that can take dynamically generated parametric data. Finally the abstract usage pattern database is encrypted and compressed and ready for distribution.

To use the abstract usage pattern database for real life load testing of a device under test, the device under test is functionally mapped to the abstract usage pattern database in the step 60. For example, in the above mentioned used cars web site, a sequence of operations constituting a functoid translates to a sequence of HTTP POST operations with the parametric data. Such a mapping is established using a visual tool as well as through scripting. Results of the step 60 are used to create a usage pattern database for the device under test at the step 62. Once the mapping is established and the usage pattern database is created, the usage pattern database and the mapping definition are loaded on to the network load tester as a test suite at the step 64. At the step 66, the network load tester executes the sequences, thereby orchestrating real life load on the device under test.

The testing software on the processor boards preferably performs the required tests. These tests include functionality tests, load/stress tests, conformance tests and interoperability tests. The testing software also includes a test suite loader and a test agent software. The test suite loader loads test cases and the proper test software onto the processor board for a test. The test agent software enables communications with the test management module and performs tasks including start, stop, monitor, report, orchestrate tests and collect results. The test agent provides for scripting features whereby test parameters and sequences are orchestrated.

Functional testing in this context involves the execution of test cases that test a system for functionality. For routers, this can mean testing various protocols for data transfer as well as control. The system can be treated as a black-box with well-defined input and output points or interfaces. The input and output points are used to engage test cases and results are collected to check against the required results. Functionality test software in many cases generates packets according to a protocol through some ports and collects the results from the device/application under test through other ports. The results are sent for analysis to the host/management system.

Load/stress testing involves the creation of simulated load onto the system under test, to test the systems behavior in worst-case load scenarios. Such a test indicates whether or not the system breaks or misbehaves under stress. Load/stress testing also helps size a device, solution or product for marketing and deployment purposes, and ensures that statistical quality of service (QoS) requirements are met for media-intensive applications like streaming and voice over IP. In most cases, load/stress test software generates protocol traffic at a very high rate through some of the configured ports and collects results from the device/application under test through other ports. A load/stress test can also be performed in conjunction with functionality tests.

Conformance tests capture the technical description of a specification and measure whether the device or system faithfully implements the specification. Conformance tests increase the level of confidence in the system. For routers, conformance tests can be done on the routing protocols. For other devices/applications, conformance testing can be done using standard or reference protocol implementations. Conformance test software will implement protocols to specification and engage applications/devices. Conformance to a protocol specification is verified and errors or warnings are sent for analysis to the management software.

Interoperability testing makes sure that different versions or implementations from multiple vendors work together. Selected functionality and conformance test cases are executed with multiple systems connected. For routers, typical functions towards proper operation, like connection establishment, routing table exchange, update and error recovery are tested. Interoperability test software generates and consumes protocol data by sending packets to a device/application that connects to other similar devices and collects data from the other devices. These devices can be from the same vendor or multiple vendors. Interoperability tests are especially suited for router and network infrastructure devices testing.

The software framework on the control board includes test manager software and host interface software. The control board runs software that interfaces with the Test Director or with an end user directly, and also communicates with the test agent software running on the processor card for test loading, control, reporting and analysis. The test manager software provides overall management and control of the testing operations. The test manager software has a web interface for end users to work directly with the system. The host interface software provides a scripting, as well as, an API interface to the test manager. The host interface allows a host system like a PC to operate and manage tests through a custom interface. This interface provides programmability for custom test-suite creation, scripting, test orchestration and results collection.

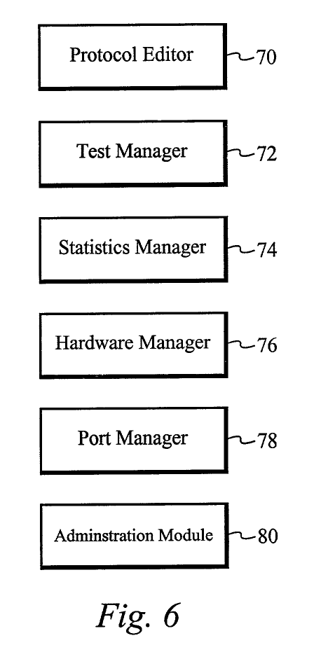

The network load testing device of the present invention also includes a configuration/management tool to be used by the end user to control the test equipment. Preferably, the software module is included within the Test Director. The Test Director includes the software that configures the processor boards, loads test suites, monitors tasks, collects test results, and reports the results to the end user. FIG. 6 illustrates the software module according to the preferred embodiment of the present invention. The software module includes a Protocol Editor 70, a Test Manager 72, a Statistics Manager 74, a Hardware Manager 76, a Port Manager 78, and an Administration Module 80. The Protocol Editor 70 is a tool that is used to add a new protocol to the system. The Protocol Editor 70 provides the user with a template (a stream of bits) that can be edited (bit/byte wise). After editing, the user preferably names this protocol. This protocol is then added to the list of available protocols that is maintained by the Protocol Editor 70. A wizard is also available in the Protocol Editor 70 to help to user configure protocol settings, such as setting protocol versions and optional features to be exercised. Once the user finishes with the protocol specification, the protocol specification can be saved. The Protocol Editor adds this protocol to the list of other protocols that it maintains.

The Test Manager 72 is responsible for conducting the quality of service testing on the DUT. The Test Manager 72 provides an interface that can be used to specify the testing parameters and conduct various kinds of tests on the device. This allows the user to specify the parameters to be tested. The user can specify parameters including latency, throughput, packet loss, customize packet content, specify traffic scheduling, set auto fields, specify individual test options, specify whether the device is to be tested with multiprotocol traffic, save a test configuration, start/stop tests and back-to-back test. A back-to-back test tests the buffering capability of the device under test.

The Statistics Manager 74 analyzes the results of the various tests conducted on the device and generates statistics and other useful information for the user. The Statistics Manager 74 generates statistics based on test results, displays statistics in various forms, and saves statistics for future reference.

The Hardware Manager 76 manages the hardware associated with the system. This includes connecting to the chassis and configuring the test equipment, IP configuration (setting the IP address of the chassis), and configuring existing cards in the chassis. An end user can configure a transmit setup and/or a trigger setup for each processor card. Transmit setup is the type of traffic pattern that the processor board can generate. The traffic pattern could either be “continuous” or “burst” mode. In the continuous mode, the processor board generates packets at a continuous rate, whereas in the burst mode the packets are generated in bursts, i.e., the traffic generation would not be smooth. The trigger setup is used to configure the processor board to listen for certain predefined triggers. When the triggers are set, a transmitting processor board generates packets with these trigger patters. A receiving processor board, upon recognizing such patterns, then performs appropriate actions, including maintaining count of such packets.

The Port Manager 78 is used to configure the ports in the network load testing device or system. For example, each port can be assigned an IP address. The end user can set each port to a transmit mode, a receive mode, or a transmit/receive mode.

The Administration Module 80 manages the user accounts for the system among other administrative tasks.

The network load tester of the present invention includes network processors for wire-speed processing, a real-time operating system for performance and loadable custom protocol stacks (software) for different applications. The flexibility of software and the performance of the network processors enables extremely high performance at wire-speed operations. The network load tester addresses all layers of the Internet protocol stack from core routing to web services in a box. The network load tester is scalable into a system capable of simulating millions of users. Such a system is easy to modify and adapt and enables remote, in-the-field, on-the-fly configuration.

When a test is to be performed that is to use a new application or device protocol, the new protocol is downloaded as a customized protocol stack to the processor board via the host interface on the processor board. This download is under the control of the Test Director. A first portion of the downloaded customized protocol stack is directed to the layers 4-7 of the OSI model, and this first portion is loaded into the high-speed memory on the processor board. A second portion of the downloaded customized protocol stack is directed to the layers 1-3 of the OSI model, and this second portion is loaded into the network processors as a micro-program. A test suite corresponding to the new protocol can also be downloaded to the high-speed memory in the processor board.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiment chosen for illustration without departing from the spirit and scope of the invention.

We claim:

1. A network testing device comprising:
a. a central processing unit;
b. a memory coupled to the central processing unit, wherein the memory includes a real-time operating system and a customizable protocol stack; and
c. one or more network processors coupled to the central processing unit and the memory, wherein the one or more network processors are microprogrammable,
whereby the one or more network processors and the customizable protocol stack are configurable to test across all layers of the Open Systems Interconnect reference model.
